(19) United States
(12) Patent Application Publication
(10) Pub. No.: US 2023/0251354 A1
(43) Pub. Date: Aug. 10, 2023

(54) COMPACT BEAM STEERING MECHANISM AND SYSTEM

(71) Applicant: Santec Corporation, Komaki (JP)

(72) Inventor: Changho Chong, Los Altos, CA (US)

(73) Assignee: Santec Corporation, Komaki (JP)

(21) Appl. No.: 17/668,587

(22) Filed: Feb. 10, 2022

(51) Int. Cl. G01S 7/481; G02B 26/10; G02B 26/08

(52) U.S. Cl. CPC G01S 7/4817; G02B 26/10; G02B 26/0816

(57) ABSTRACT

Mechanisms and systems for compact beam steering disclosed. A beam scanning device can include a first scanner mirror that receives a beam of light generated by a light source, and steers the beam of light through a reflection mechanism. The beam scanning device can include a second scanner mirror that receives the beam of light from the reflection mechanism. The beam scanning device can include a set of gears coupled to the first scanner mirror and the second scanner mirror that, when driven, rotate the first scanner mirror and the second scanner mirror at predetermined speeds. The beam scanning device includes an actuator that rotates the set of gears, the first scanner mirror, and the second scanner mirror at the predetermined speeds, causing the beam of light to reflect across the first and second scanner mirrors in a predetermined scanning pattern.

### BACKGROUND

The present invention relates generally to the field of light detection and ranging (LIDAR) scanners. Conventional LIDAR scanners require complex mechanical components to perform multidimensional (e.g., two-dimensional (2D), three-dimensional (3D), etc.) scans. These complex mechanical systems may be more prone to failure, and are too large to integrate into useful systems.

### SUMMARY

The systems of the present disclosure provide improved beam scanning devices that can perform 2D LIDAR scanning with multiple scanning mirrors disposed in the same plane. At least one aspect of the present disclosure is directed to a beam scanning device. The beam scanning device can include a first scanner mirror that receives a beam of light generated by a light source. The first scanner mirror can steer the beam of light through a reflection mechanism. The beam scanning device can include a second scanner mirror that receives the beam of light from the reflection mechanism. The beam scanning device can include a set of gears coupled to the first scanner mirror and the second scanner mirror that, when driven, rotate the first scanner mirror and the second scanner mirror at predetermined speeds. The beam scanning device can include an actuator that rotates the set of gears, the first scanner mirror, and the second scanner mirror at the predetermined speeds, causing the beam of light to reflect across the first and second scanner mirrors in a predetermined scanning pattern.

In some implementations, the first and second scanner mirrors scan the beam of light in the same plane. In some implementations, the reflection mechanism can include a mirror that rotates a scanned plane of the beam of light emitted from the first scanner mirror to be orthogonal to a scanning plane of the second scanner mirror. In some implementations, the actuator is one of a stepper motor, a servo motor, or an electric motor with a speed control device. In some implementations, the set of gears are a set of pulleys, and the actuator rotates the first and second scanner mirror by rotating the set of pulleys and one or more belts connecting the set of pulleys.

In some implementations, the actuator can include an encoder or a position sensor that monitors and regulates a rotational speed of the actuator. In some implementations, a first subset of the set of gears has a first predetermined gear ratio, and a second subset of the set of gears has a second predetermined gear ratio different from the first gear ratio. In some implementations, the first scanner mirror is rotated responsive to actuation of the first subset and the second scanner mirror is rotated responsive to actuation of the second subset.

In some implementations, the first predetermined gear ratio is 1:12, and the second predetermined gear ratio is 6:1. In some implementations, the second predetermined gear ratio is greater than the first predetermined gear ratio. In some implementations, the first scanner mirror and the second scanner mirror rotate such that the beam of light completes the predetermined scanning pattern in at a rate of about 10 Hz. In some implementations, the beam of light is output from the beam scanning device and scans an external object in the predetermined scanning pattern. In some implementations, the predetermined scanning pattern is a two-dimensional scanning pattern.

At least one other aspect of the present disclosure is directed to a time-of-flight (ToF) LIDAR system. The ToF LIDAR system can include a light source that emits a beam of light for a predetermined duration. The ToF LIDAR system can include a beam scanner. The beam scanner can include a first scanner mirror that reflects the beam of light generated by the light source, and steers the beam of light through a reflection mechanism. The beam scanner can include a second scanner mirror that receives the beam of light from the reflection mechanism. The beam scanner can include a set of gears coupled to the first scanner mirror and the second scanner mirror that, when driven, rotate the first scanner mirror and the second scanner mirror at predetermined speeds. The beam scanner can include an actuator that rotates the set of gears, the first scanner mirror, and the second scanner mirror at the predetermined speeds, causing the beam of light to reflect across the first and second scanner mirrors in a predetermined scanning pattern. The ToF LIDAR system can include a range detector that receives the beam of light responsive to the beam of light reflecting off an object in an external environment.

In some implementations, the first and second scanner mirrors scan the beam of light in the same plane. In some implementations, the reflection mechanism can include a mirror that rotates a scanned plane of the beam of light emitted from the first scanner mirror to be orthogonal to a scanning plane of the second scanner mirror. In some implementations, the actuator is one of a stepper motor, a servo motor, or an electric motor with a speed control device. In some implementations, the actuator can include an encoder or a position sensor that monitors and regulates a rotational speed of the actuator. In some implementations, a first subset of the set of gears has a first predetermined gear ratio, and a second subset of the set of gears has a second predetermined gear ratio different from the first gear ratio. In some implementations, the first scanner mirror is rotated responsive to actuation of the first subset and the second scanner mirror is rotated responsive to actuation of the second subset.

At least one other aspect of the present disclosure is directed to a frequency-modulated continuous-wave (FMCW) LIDAR system. The FMCW LIDAR system can include a light source that emits a beam of light continuously in a predetermined pattern of optical frequencies. The FMCW LIDAR system can include a beam scanner. The beam scanner can include a first scanner mirror that reflects the beam of light generated by the light source, and steers the beam of light through a reflection mechanism. The beam scanner can include a second scanner mirror that receives the beam of light from the reflection mechanism. The beam scanner can include a set of gears coupled to the first scanner mirror and the second scanner mirror that, when driven, rotate the first scanner mirror and the second scanner mirror at predetermined speeds. The beam scanner can include an actuator that rotates the set of gears, the first scanner mirror, and the second scanner mirror at the predetermined speeds, causing the beam of light to reflect across the first and second scanner mirrors in a predetermined scanning pattern. The FMCW LIDAR can include a light receiver circuit that receives the beam of light responsive to the beam of light reflecting off an object in an external environment, and determines a distance to the object based on a frequency of the beam of light.

In some implementations, the first and second scanner mirrors scan the beam of light in the same plane. In some implementations, the reflection mechanism comprises a mirror that rotates a scanned plane of the beam of light emitted from the first scanner mirror to be orthogonal to a scanning plane of the second scanner mirror. In some implementations, the actuator is one of a stepper motor, a servo motor, or an electric motor with a speed control device. In some implementations, the actuator can include an encoder or a position sensor that monitors and regulates a rotational speed of the actuator.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. As used in the specification and in the claims, the singular form of ‘a’, ‘an’, and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a perspective view of an example beam scanning device, in accordance with one or more implementations;

FIG. 2 depicts a top view of the example beam scanning device depicted in FIG. 1, in accordance with one or more implementations.

FIG. 3 depicts a side view of the example beam scanning device depicted in FIGS. 1 and 2, in accordance with one or more implementations;

FIG. 4 depicts an example beam scanning device with an example alternative gear arrangement, in accordance with one or more implementations;

FIGS. 5A and 5B depict front views of example beam scanning devices each having different gear arrangements, in accordance with one or more implementations;

FIG. 6 depicts a perspective view showing an example two-dimensional (2D) scanning pattern of an example beam scanning device similar to those described herein, in accordance with one or more implementations;

FIG. 7 depicts a cross-sectional side view of an example transponder block of an FMCW LIDAR system, in accordance with one or more implementations;

FIG. 8 depicts a cross-sectional side view of an example transponder block of an FMCW LIDAR system, in accordance with one or more implementations; and

FIG. 9 depicts a top view of an example transponder block of an FMCW LIDAR system, in accordance with one or more implementations.

### DETAILED DESCRIPTION

Below are detailed descriptions of various concepts related to, and implementations of, techniques, approaches, methods, apparatuses, and systems for compact beam steering. The various concepts introduced above and discussed in greater detail below may be implemented in any of numerous ways, as the described concepts are not limited to any particular manner of implementation. Examples of specific implementations and applications are provided primarily for illustrative purposes.

The devices, mechanisms, and systems described herein provide improved compact beam steering for multidimensional scanning devices, such as LIDAR devices. Conventional LIDAR systems include large and complex mechanical parts that occupy a large space, making them impracticable to integrate with modern devices and systems, such as autonomous vehicles. This is especially true for multidimensional LIDAR scanning devices, such as two-dimensional beam scanning mechanisms, which sacrifice volume and mechanical complexity to achieve wider scan area with a large beam size. Similarly, compact solutions such as micro-electromechanical system (MEMS) mirrors can achieve two-dimensional beam scanning, but have significantly limited performance. For example, such devices have either small mirror size or restricted scanning angles. In addition, such beam scanners are not suitable for applications that require high reliability under harsh operational environment, such as for autonomous ground vehicles, or drones, which require reliability, small size, and light weight, all without sacrificing beam scanning area or beam size. Generally, conventional multidimensional scanners include a combination of two independent scanners, with one mirror placed perpendicular to a second mirror. However, such arrangements are mechanically complex, because it requires a mechanism that can synchronize the scanning timing to cover the field-of-view (FOV) constantly.

The devices, mechanisms, and systems described herein solve these and other issues by providing a compact beam scanning device that achieves small size, light weight, mechanical simplicity, and a large scanning area by utilizing a beam scanner layout and mechanism. The beam scanning devices and mechanisms described herein utilize multiple scanning mirrors that rotate in the same plane, in addition to various beam steering mirrors and prisms, to provide a large two-dimensional scanning area with relative mechanical simplicity. These and other aspects are described in detail herein.

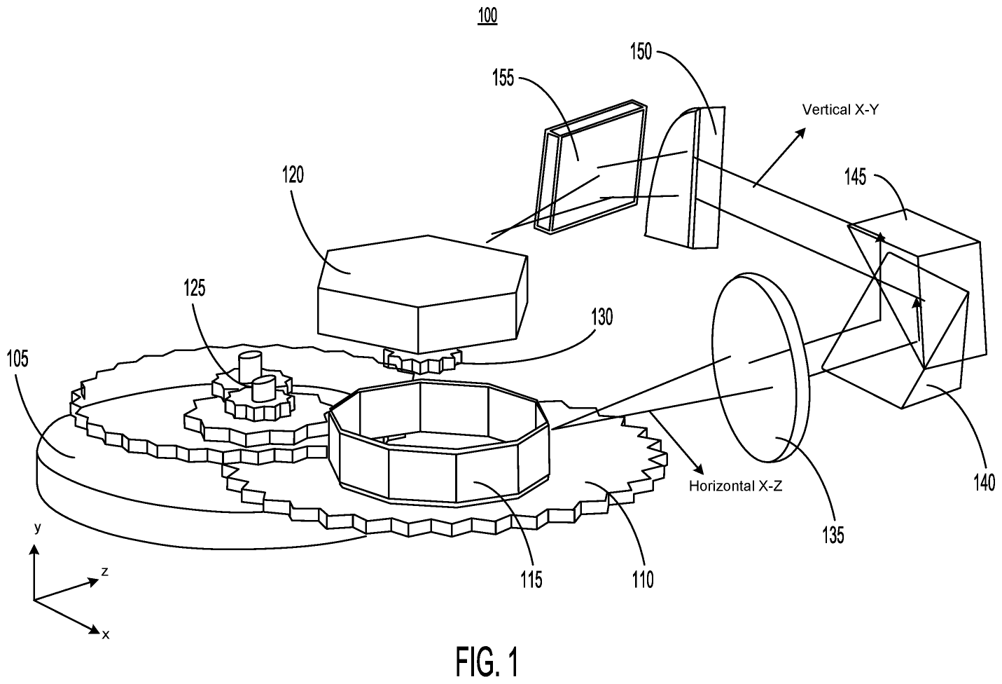

Referring to FIG. 1, depicted is a perspective view of an example beam scanning device 100, according to one or more implementations. The beam scanning device 100 is a compact beam scanning device that includes a first scanner mirror 115 and a second scanner mirror 120, enabling beam scanning in two dimensions. The beam scanning device can include beam scanning components (e.g., the lens 135, the first mirror 140 and the second mirror 145, the second lens 150, and the third mirror 155), which can rotate a scanned beam of light reflected from the first scanning mirror 115 by 90 degrees, and steer the rotated beam such that it strikes the second scanner mirror 120.

The first scanner mirror 115 and the second scanner mirror 120 are each coupled to a first gear 110 and a second gear 130. The first scanner mirror 115 is fixed to the first gear 110 such that, when the first gear 110 rotates, the first scanner mirror 120 rotates by a proportional amount along the same axis. Likewise, the second scanner mirror 120 is fixed to the second gear 130 such that, when the second gear 130 rotates, the second scanner mirror 120 rotates by a proportional amount along the same axis. Each of the first gear 110 and the second gear 130 can be connected to the set of gears 125, which may create a suitable gear ratio between the motor 105, the first gear 110, and the second gear 130. The set of gears 125 can include any number of gears or other components that can cause the first scanner mirror 115 and the second scanner mirror 120 to rotate.

For example, in some implementations, the first gear 110, the second gear 130, and the set of gears 125 can be one or more pulleys, which may be connected using a set of belts or other suitable attachment mechanisms. In some implementations, one or more chains may be used to transfer rotational energy between the first gear 110, the second gear 130, or the set of gears 125. The first gear 110, the second gear 130, and the set of gears 125 may rotate one or more shafts, which may also secure the first gear 110, the second gear 130, or the set of gears 125 to a housing or another device. As shown, set of gears 125 rotationally couples both the first gear 110 and the second gear 130 to the motor 105, such that the motor 105 drives both the first gear 110 and the second gear 130 at the same time.

The first gear 110 and the second gear 130 may have predetermined gear ratios with respect to the set of gears 125, such that the first gear 110 and the second gear 130 (and therefore the first scanner mirror 115 and the second scanner mirror 120) rotate at predetermined rates relative to one another. For example, the ratio between first gear 110 and the set of gears 125 can be 1:12, such that when the motor 105 rotates at 600 revolutions-per-minute (rpm), the first gear 110 rotates at 50 rpm. Likewise, the ratio between the second gear 130 and the set of gears 125 can be 6:1, such that when the motor 105 rotates at 600 rpm, the second gear 130 is rotated at 3600 rpm. However, it should be understood that alternative gear arrangements and ratios are possible, such that each of the first gear 110 and the second gear 130 rotate at desired speeds relative to one another. Generally, each of the first scanner mirror 115 and the second mirror 145 are responsible for scanning along a single axis. An advantage of the techniques described herein provide automatic synchronization of the first scanner mirror 115 and the second scanner mirror 120, because the first gear 110 and the second gear 130 are connected to the same set of gears 125 and therefore are driven by the same motor 105.

The first scanner mirror 115 can be a polygonal mirror with multiple reflective faces. For example, the first scanner mirror 115 may have twelve scanner faces. However, it should be understood that the first scanner mirror 115 can include any number of faces, such as ten faces, as pictured. Each face of the first scanner mirror 115 can reflect a beam of light for a complete scan in the vertical (or horizontal, depending on the arrangement of the beam steering components) direction. As shown in FIG. 1, as the first scanner mirror 115 rotates, each face reflects a beam of light along a single pathway across the x-z vertical plane. However, this scan is subsequently rotated by the beam steering components described herein, and then reflects off the second scanner mirror 120, as shown. The number of faces of the first scanner mirror 115 can correspond to the desired number of scans (e.g., two-dimensional scans) per second. For example, if the first gear 110, the set of gears 125, and the motor 105 are configured such that the first scanner mirror 115 rotates at 50 rpm and includes twelve faces, the first scanner mirror 115 can complete ten scans per second (a rate of 10 Hz). When twelve faces are used, the first scanner mirror 115 can provide a 60 degree scanning range.

The second scanner mirror 120 can be similar to the first scanner mirror 115, and may be a polygonal mirror with multiple reflective faces. For example, the second scanner mirror 120 may have five scanner faces. However, it should be understood that the second scanner mirror 120 can include any number of faces, such as six faces, as pictured. Each face can correspond to a complete scan in the horizontal (or vertical, depending on the arrangement of the beam steering components) direction. As shown in FIG. 1, as the second scanner mirror 120 rotates, each face reflects a beam of light along a single pathway across the y-z vertical plane. The beam of light reflected off the first scanner mirror 115 and transmitted through the beam steering components (e.g., the lens 135, the first mirror 140 and the second mirror 145, the second lens 150, and the third mirror 155) can strike the surface of the second scanner mirror 120. The light beam reflected from the second scanner mirror 120 can exit the beam scanning device 100, for example, to reflect off, and thereby scan, an object in an external environment.

The number of faces of the second scanner mirror 120 can correspond to the desired number of scans per second. For example, if the second gear 130, the set of gears 125, and the motor 105 are configured such that the second scanner mirror 120 rotates at 3600 rpm and includes five faces, the second scanner mirror 120 can complete ten scans per second (a rate of 10 Hz). This is because the second scanner mirror 120 can scan across the x-z plane, and must therefore complete thirty scans horizontal scans for every vertical scan to complete a full two-dimensional scan. Therefore, in the foregoing example, the first scanner mirror 115 (with twelve faces and rotating at 50 rpm) completes ten scans per second (where each scan corresponds to a full vertical scan), while the second scanner mirror 120 performs 300 scans per second (with five faces and rotating at 3600 rpm), generating 30 scans per one scan of the first scanner mirror 115. However, it will be appreciated that the first scanner mirror 115 and the second scanner mirror 120 may have any number of faces or may rotate at any desired speed relative to one another by configuring the gear ratios of the first gear 110, the second gear 130, and the set of gears 125, and the rotational speed of the motor 105.

The motor 105 can be any type of motor that can rotate at a substantially constant rotational speed. For example, the motor 105 may be a stepper motor that rotates at a predetermined rotation speed (e.g., 60 rpm). In some implementations, the motor 105 may be a servo motor, or may be a direct-current (DC) motor that includes an encoder or other circuitry that maintains the rotational speed of the motor 105 at a constant speed. A stepper motor can be a brushless DC motor that divides a complete rotation into a number of equal steps. Electric signals can be provided to the inputs of the stepper motor to actuate the stepper motor at a constant rotational rate. The motor 105 can be any type of stepper motor (e.g., a unipolar stepper motor, a bipolar stepper motor, a high-phase stepper motor, etc.). The beam scanning device 100 can include driving circuitry that drives or otherwise causes the motor 105 to rotate at a predetermined rate.

As shown, the beam scanning device 100 includes various beam steering components (e.g., the first lens 135, the first mirror 140 and the second mirror 145, the second lens 150, and the third mirror 155) that can rotate the scanned beam reflected from the first scanner mirror 115 by 90 degrees. Rotating the scanned beam of light by 90 degrees allows multiple scanner mirrors that rotate in the same plane (e.g., the first scanner mirror 115 and the second scanner mirror 120) to reflect the beam of light and perform a two-dimensional scan. After reflecting from the first scanner mirror 115, a beam of light (which may be provided from a light emitter as described herein) can be directed at a first lens 135. The first lens 135 can focus the beam of light reflected from the first scanner mirror 115 to be parallel with the z-axis (shown in FIG. 1). The first lens 135 can be any type of focusing lens capable of focusing the beam of light to scan across the x-z plane. The first lens 135 can be manufactured from glass or another suitable lens material.

After being focused by the first lens, the beam of light can strike the first mirror 140, which is optically coupled to the second mirror 145 in a periscope arrangement. As shown, the periscope arrangement causes the beam of light (which is scanned in the x-z plane) to be rotated 90 degrees, such that, when reflected from the first mirror 140 and the second mirror 145, scans across the x-y plane, as shown. To do so, the first mirror 140 reflects the beam of light up in the plane folded normal to the plane of the incoming beam (e.g., the x-z plane), then the second mirror 145 reflects the beam of light again in the same plane, thereby rotating the beam of light from the x-z plane to the y-z plane. The first mirror 140 and the second mirror 145 may be any type of 45-degree reflectors, and can be manufactured from any type of reflective material suitable to reflect the beam of light.

After being reflected from the second mirror 145, the beam of light enters the second lens 150, which converges the beam of light onto the third mirror 155. The second lens 150 can be any type of converging lens, which can converge rays of light traveling parallel to its principle axis. The converging lens can converge the beam of light (which is configured in a vertical scanning pattern as the first scanner mirror 115 rotates) such that the light can converge to a focal point prior to striking the second scanner mirror 120, to invert the scanning beam of light as shown in FIG. 1. The third mirror 155 reflects the beam of light after it exits the second lens 150 to direct the beam of light towards the second scanner mirror 120. As shown in this example implementation, the focal point of the light is between the third mirror 155 and the second scanner mirror 120. As described herein above, the second scanner mirror 120 can scan at a different rate as the first scanner mirror 115. The second scanner mirror 120 reflects the beam of light in the plane orthogonal to the plane of the beam of light received at the scanner mirror 120.

In this way, the second scanner mirror 120 rotates and scans the beam along the x-axis, while the first scanner mirror 115 rotates at a slower rate and scans the beam along the y-axis. The beam of light is projected out from the beam scanning device 100 parallel to the z-axis to strike and thereby scan objects in an environment. The beam of light can be reflected back into and received by one or more components of a LIDAR system, which includes the beam scanning device 100. Such systems and devices are described in detail herein.

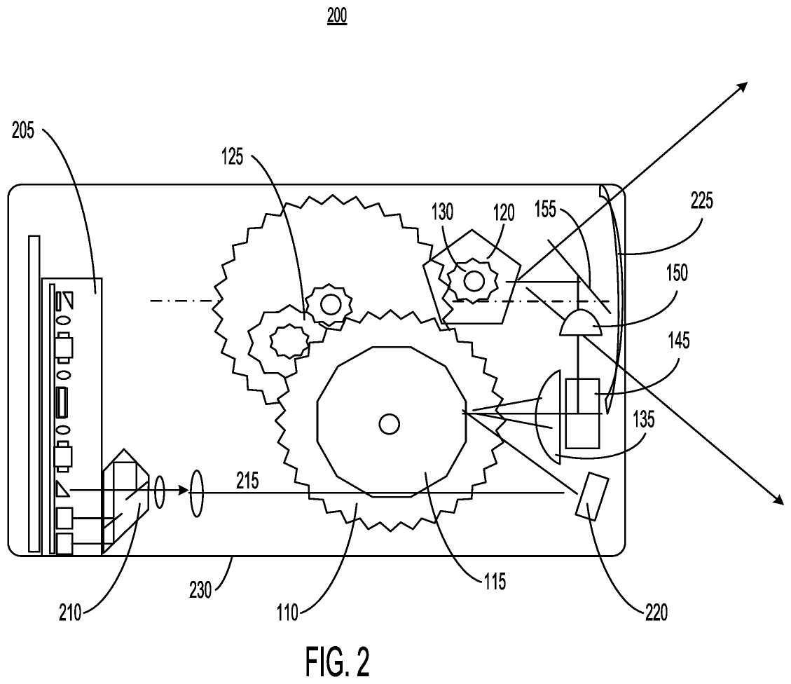

Referring to FIG. 2, depicted is a top view of the example beam scanning device 100 depicted in FIG. 1, integrated into a LIDAR system 200 in accordance with one or more implementations. As shown, each of the components of the beam scanning device 100 (e.g., the motor 105 (omitted from this figure for ease of visualization), the first gear 110, the first scanner mirror 115, the second scanner mirror 120, the set of gears 125, the second gear 130, the first lens 135, the first mirror 140 (omitted from this figure for ease of visualization), the second mirror 145, the second lens 150, and the third mirror 155, etc.) described in connection with FIG. 1 may be integrated into a housing 230 of the LIDAR system 200. The LIDAR system 200 may be any type of LIDAR system, such as a ToF LIDAR system or a FMCW LIDAR system. The housing 230 may have dimensions of 86 millimeters (mm) long by 56 mm wide, for example. The housing 230 can be any shape that can accommodate a beam scanning device, such as the beam scanning device 100 described in connection with FIG. 1.

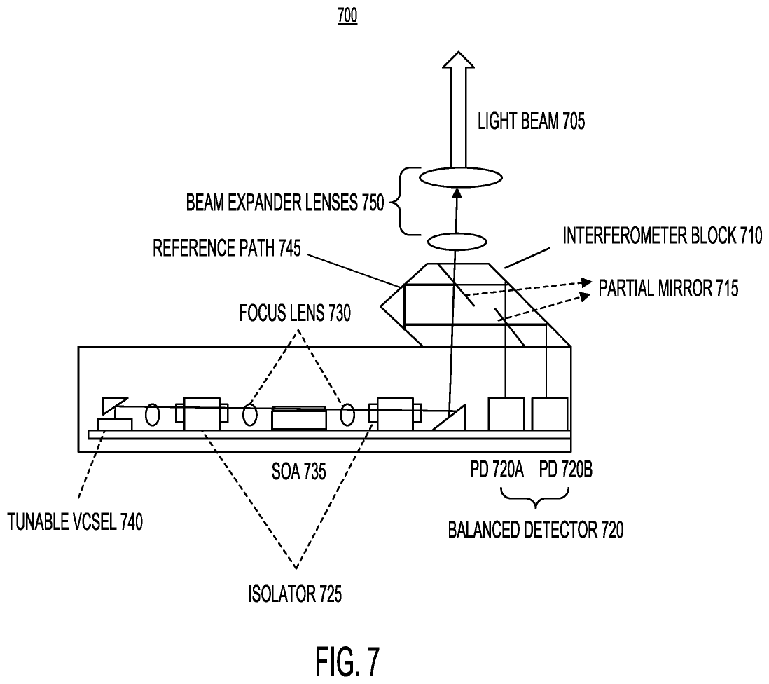

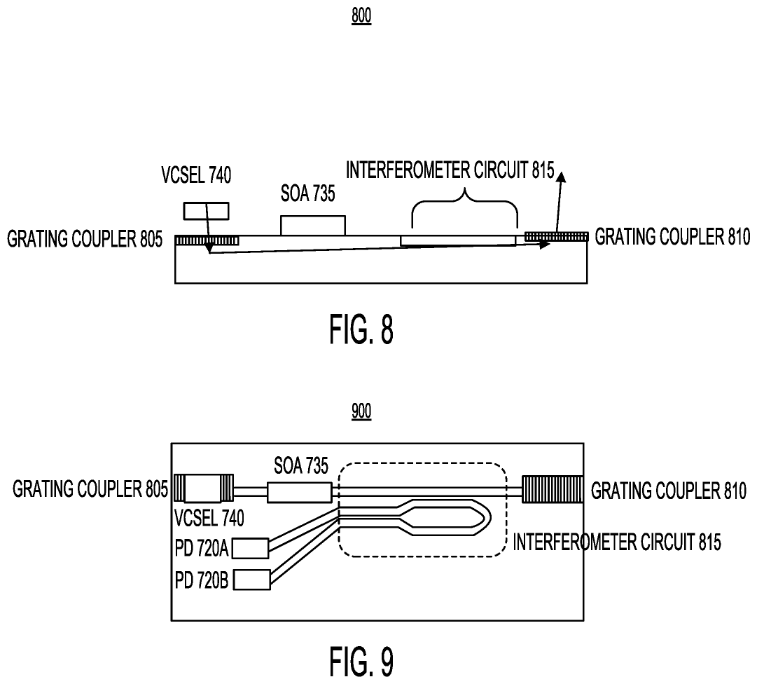

As shown, the LIDAR system 200 includes at least one transponder block 205, which may be or may include any of the transponders described in connection with FIGS. 7-9. The transponder 205 can include an interferometer block 210 (which may be the interferometer block 710 described in connection with FIG. 7, or the interferometer circuit 815 described in connection with FIGS. 8 and 9). The interferometer block 210 can emit a beam of light 215, which may have predetermined characteristics (e.g., wavelength, intensity, width, pulse duration, etc.) toward the reflecting mirror 220, which may be any type of mirror or reflective surface suitable to reflect the beam of light 215 toward the first scanner mirror 115. The beam of light 215 then strikes the first scanner mirror 115 and propagates through the beam scanning device 100, as described in connection with FIG. 1. The beam of light 215 is finally reflected from the second scanner mirror 120, and output from the output lens 225, which can be any type of lens suitable to emit the beam of light 215 from the LIDAR system 200 such that it can strike an object in an external environment. After striking an object in the external environment, the beam of light 215 can be reflected back toward and captured by the LIDAR system 200.

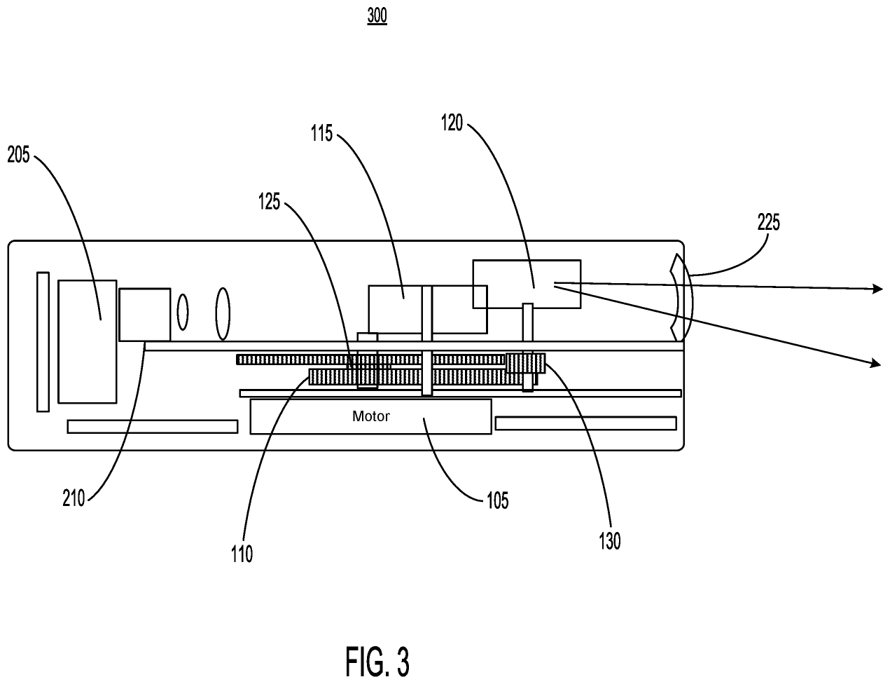

A side view 300 of the LIDAR system 200, including the beam scanning device 100 described in connection with FIGS. 1 and 2, is depicted in FIG. 3. As shown, the light is emitted from the device outward via the output lens 225. After striking an object in the external environment, the light can be reflected back to the LIDAR system 200 and be absorbed by a receiver (not pictured). Characteristics of the received light can be used, for example, to determine a distance to objects or map the surface of an object via one or more scanning algorithms. The light emitted by the LIDAR system 200 can be a pulse having a predetermined duration, as used in a ToF LIDAR system, or may be a continuous wave of light emitted at a variety of frequencies, as in a FMCW LIDAR system.

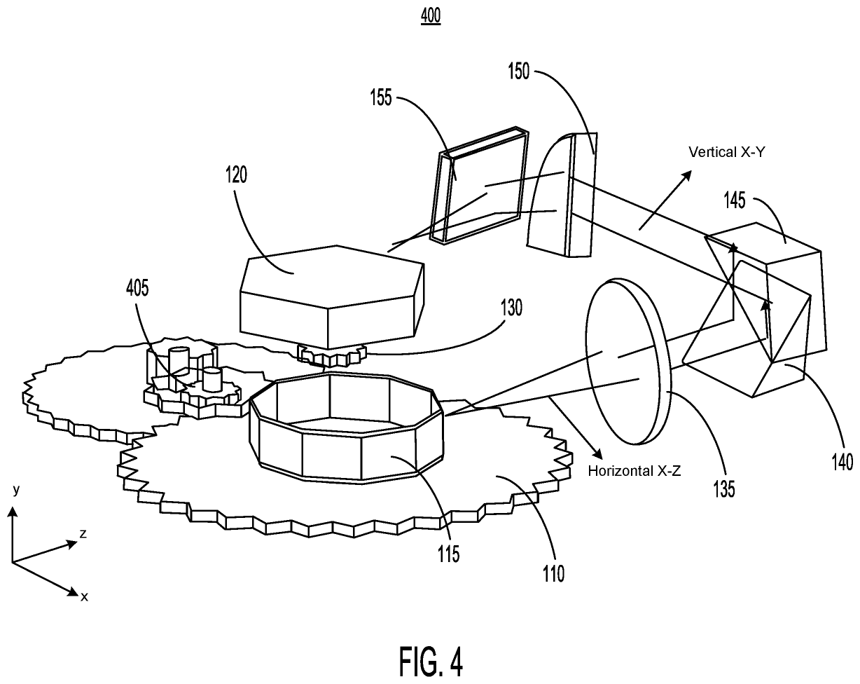

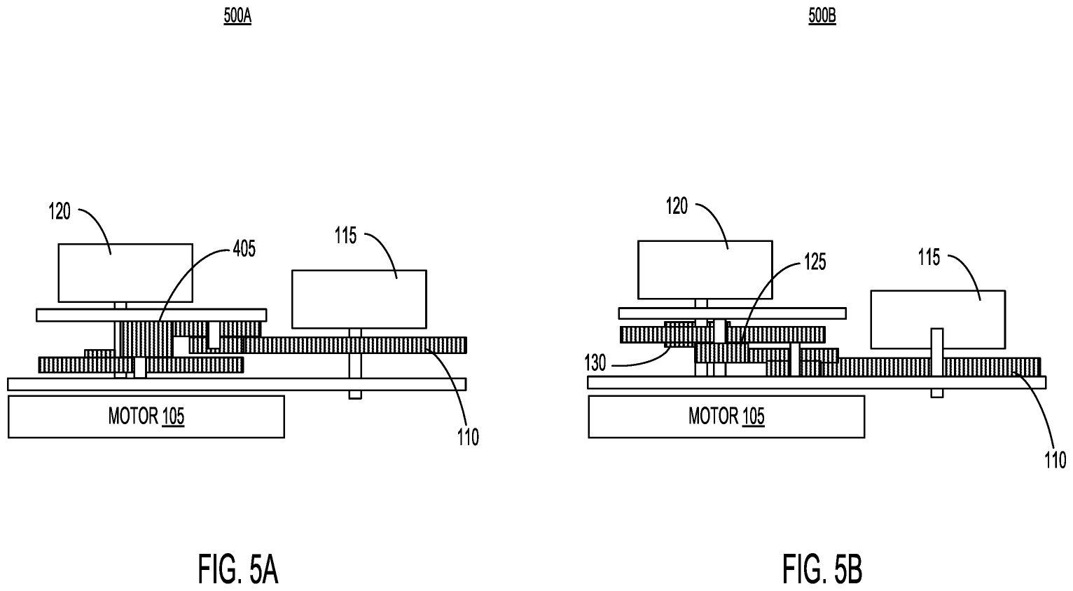

Alternative configurations of gears or other elements used to rotate multiple scanner mirrors may also be used. Referring to FIG. 4, depicted is an example beam scanning device 400, similar to the beam scanning device 100 described in connection with FIG. 1, with an example alternative gear arrangement, in accordance with one or more implementations. As shown, the beam scanning device 400 can include all of the components of the beam scanning device 100 (the motor 105 is omitted from FIG. 4 for ease of visualization), but with an alternative set of gears 405. The alternative set of gears 405 (and the first gear 110 and the second gear 130) may be arranged such that the first gear 110 is positioned above the second gear 130. The differences between the gear configurations are further illustrated in FIGS. 5A and 5B.

Referring to FIGS. 5A and 5B, depicted are front views 500A and 500B of example beam scanning devices 400 and 100, respectively, each having different gear arrangements, in accordance with one or more implementations. As shown in FIG. 5A, the alternative set of gears 405 is are configured such that the first gear 110 may be positioned above the second gear 130 (which is occluded by other gears in FIG. 5A, and therefore not indicated with a reference numeral). In contrast, as shown in FIG. 5B (which depicts the beam scanning device 100), the set of gears 125 has an arrangement that permits the second gear 130 to be positioned above the first gear 110. It will be appreciated that other arrangements of the gears described herein are contemplated, and that the examples provided herein should not be considered limiting.

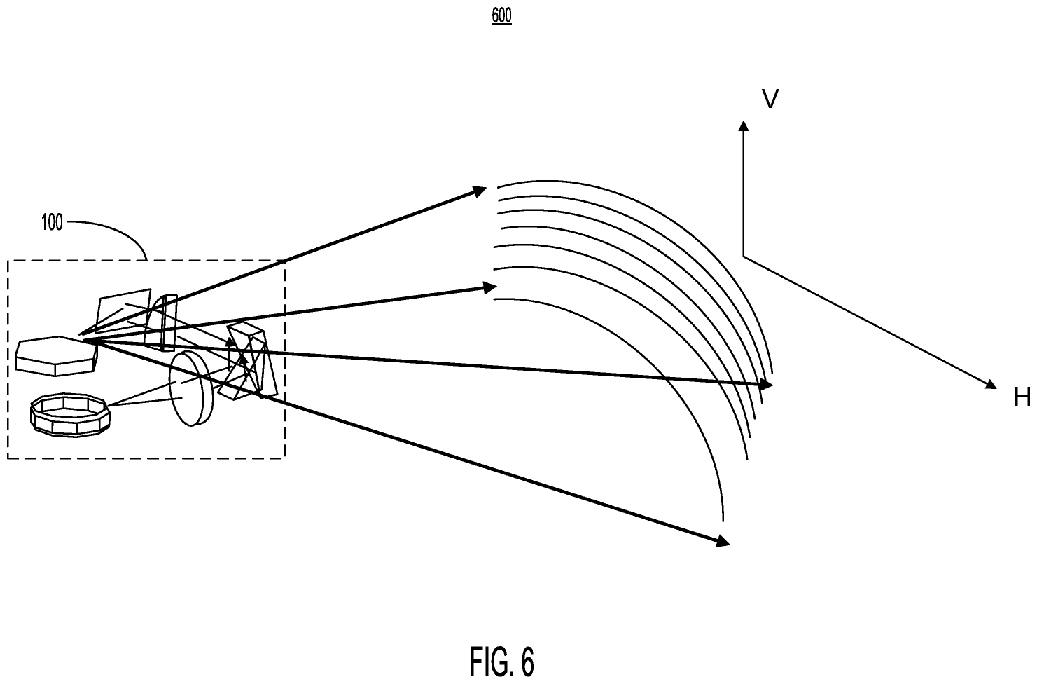

Referring to FIG. 6, depicted is a perspective view 600 showing an example two-dimensional scanning pattern of an example beam scanning device similar to the beam scanning device 100 described in connection with FIG. 1, in accordance with one or more implementations. As shown, the light beam emitted by the beam scanning device 100 follows a horizontal pathway (illustrated by each horizontal stripe), which is substantially parallel to the H-axis. The horizontal scanning is achieved using the second scanner mirror 120 described in connection with FIG. 1, which, in this example, scans faster than the first scanner mirror 115. The number of faces and the rotational speeds of each of the first scanner mirror 115 and the second scanner mirror 120 are selected such that as one face of the second scanner mirror 120 completes one horizontal scan, the first scanner mirror 115 rotates to move the beam of light downward along the V-axis, thereby scanning along the H-axis just below the previous scan line. This creates the multiple scanning patterns shown in FIG. 6, which collectively create a full two-dimensional scan of a portion of an external environment. Various configurations may be achieved by changing the rotational speed of the first or second scanner mirrors, or by changing the rotational direction of the first or second scanner mirror. For example, in some implementations, the scanning along the V-axis is made faster than along the H-axis by changing the set of gears 125 (or pulleys) to rotate the first scanner mirror 115 faster than the second scanner mirror 120.

Referring to FIG. 7, depicted is a cross-sectional side view of an example transponder block 700 that may be integrated into an FMCW LIDAR system, in accordance with one or more implementations. As shown, the transponder block 700 can emit a beam of light 705. The transponder block 700 can include at least one interferometer block 710, which itself may include one or more partial mirrors 715. Light propagating through the interferometer block 710 may follow one or more reference paths 745, and, upon exiting the interferometer block 710, propagate through one or more beam expander lenses 750, which can expand the beam of light 705 such that it has a predetermined beam width. In some implementations, the interferometer block 710 (and some other components of the transponder block 700) can be part of a silicon photonics integrated chip, as shown in FIGS. 8 and 9.

The transponder block 700 of can include a laser light source, shown here as the tunable vertical cavity surface-emitting laser (VCSEL) 740. In some implementations, other types of light sources may be use, such as a distributed feedback (DFB) laser, a distributed Bragg reflector (DBR) laser, or an external cavity laser (e.g., with a linewidth of less than 1 MHz, or a coherence length of greater than 100 meters, etc.), among others. The light emitted by the tunable VCSEL 740 can be reflected by a reflector, such that the emitted beam of light 705 is guided into one or more isolators 725 and one or more focus lenses 730. However, in some implementations, one or more of the isolators 725 or focus lenses 730 may be omitted from the transponder block 700.

In some implementations, the transponder block 700 can include a semiconductor optical amplifier (SOA) 735. The SOA 735 may include optical devices that link the emitted beam of light 705 to the interferometer block 710, which may be constructed from fiber optics or free-space optics that split the beam from the light source to the reference path and to a sample path using the one or more partial mirrors 715. The beam in the sample path is connected to the scanner mechanism (e.g., the beam scanning device 100 of FIG. 1, etc.). The fraction of light reflected back from the objects in the external environment is received by the interferometer block 710 through the scanner, and is recombined with the light from the reference path to generate a beat signal, which carries range information on the frequency domain signal (e.g., the frequency transform of the light signal, etc.). This can be used to detect a distance to the object in the external environment. Light from the interferometer block 710 can be measured using the photodetectors (PD) 720A and 720B, which collectively provide a balanced photodetector 720.

For example, the interferometer block 710 may generate an interference pattern based on the difference between light reflected off surfaces of objects in the external environment and light reflected along the reference path. The distance to the objects may be determined based on the interference pattern. For example, one or more processors or computing devices (not pictured) may be in communication with the interferometer block 710, and receive information indicating the interference pattern. The computing device can then perform analysis on the interference pattern to determine characteristics (e.g., distance, speed) of the object in the external environment.

Referring to FIGS. 8 and 9, depicted are a cross-sectional side view 800 and a top view 900 of an example transponder block 700 of an FMCW LIDAR system, in accordance with one or more implementations. As briefly described above, in some implementations, the interferometer block 710, and other components of the transponder block 700, can be part of a silicon photonics integrated chip. As shown in the cross sectional view 800, light emitted by a light source (e.g., the VCSEL 740) can be provided to a first grating coupler 805 formed at the surface of a substrate comprised of a photonics integrated chip. A photonics integrated chip can be an integrated optical circuit that can integrate multiple photonic functions, including the processing or generation of information signals imposed on optical wavelengths. The photonics integrated chip may be constructed from a material such as silicon, indium phosphide, or another suitable material.

The light beam received by the first grating coupler 805 can be guided through one or more waveguides defined in the photonics integrated chip. In some implementations, the waveguides can include mirrors or other features that guide the light along a desired pathway. As shown in the cross-sectional view 800, the waveguides (not shown) can guide the light through the SOA 735, which may be defined as part of the photonics integrated chip. Following the SOA 735, the light passes through the interferometer circuit 815, which may perform similar functions as the interferometer block 710, but is instead defined (e.g., via one or more waveguides, mirrors, or other optical features) in the photonics integrated chip. After passing through the interferometer circuit 815, the beam of light can be reflected out of the photonics integrated chip via the second grating coupler 810. The beam of light may be reflected using any reflector, such as a mirror, integrated with the photonics integrated chip.

A top view 900 of the photonics integrated chip is shown in FIG. 9. As shown, the interferometer circuit 815 includes additional waveguides that are optically coupled to the photodetectors 720A and 720B (which collectively form the balanced detector 720). Signals generated by the photodetectors 720A and 720B can be provided to one or more computing devices or sensors, which can use said signals to determine information relating to objects detected in an external environment.

While operations are depicted in the drawings in a particular order, such operations are not required to be performed in the particular order shown or in sequential order, and none of the illustrated operations are required to be performed. Actions described herein can be performed in a different order.

The separation of various system components does not require separation in all implementations.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation may be included in other implementations.

The phraseology and terminology used herein is for the purpose of description and should not be regarded as limiting. The use of “including,” “comprising,” “having,” “containing,” “involving,” “characterized by,” “characterized in that,” and variations thereof herein is meant to encompass the items listed thereafter, equivalents thereof, and additional items, as well as alternate implementations of the items listed thereafter. In one implementation, the systems and methods described herein comprise one, each combination of more than one, or all of the described elements, acts, or components.

As used herein, the terms “about” and “substantially” will be understood by persons of ordinary skill in the art and will vary to some extent depending upon the context in which they are used. If there are uses of the term which are not clear to persons of ordinary skill in the art given the context in which it is used, “about” will mean up to plus or minus 10% of the particular term.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations.

Any implementation disclosed herein may be combined with any other implementation or embodiment, and references to “an implementation,” “some implementations,” “one implementation,” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

The indefinite articles “a” and “an,” as used herein in the specification and in the claims, unless clearly indicated to the contrary, should be understood to mean “at least one.”

Uses of “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description, or any claim are followed by reference numbers, the reference numbers have been included to increase the intelligibility of the drawings, detailed description, and claims. Accordingly, neither the presence of reference numbers nor their absence has any limiting effect on the scope of any claim elements.

The systems and methods described herein may be embodied in other specific forms without departing from the characteristics thereof. The foregoing implementations are illustrative rather than limiting of the described systems and methods. The scope of the systems and methods described herein is thus indicated by the appended claims, rather than the foregoing description, and changes that fall within the meaning and range of equivalency of the claims are embraced therein.

What is claimed is:

1. A beam scanning device, comprising:
a first scanner mirror that receives a beam of light generated by a light source, and steers the beam of light through a reflection mechanism;
a second scanner mirror that receives the beam of light from the reflection mechanism;
a set of gears coupled to the first scanner mirror and the second scanner mirror that when driven rotate the first scanner mirror and the second scanner mirror at predetermined speeds; and
an actuator that rotates the set of gears, the first scanner mirror, and the second scanner mirror at the predetermined speeds, causing the beam of light to reflect across the first and second scanner mirrors in a predetermined scanning pattern.

2. The beam scanning device of claim 1, wherein the first and second scanner mirrors scan the beam of light in the same plane.

3. The beam scanning device of claim 1, wherein the reflection mechanism comprises a mirror that rotates a scanned plane of the beam of light emitted from the first scanner mirror orthogonal to a scanning plane of the second scanner mirror.

4. The beam scanning device of claim 1, wherein the actuator is one of a stepper motor, a servo motor, or an electric motor with a speed control device.

5. The beam scanning device of claim 1, wherein the set of gears are a set of pulleys, and the actuator rotates the first and second scanner mirror by rotating the set of pulleys and one or more belts connecting the set of pulleys.

6. The beam scanning device of claim 1, wherein the actuator further comprises an encoder or a position sensor that monitors and regulates a rotational speed of the actuator.

7. The beam scanning device of claim 1, wherein a first subset of the set of gears have a first predetermined gear ratio, and a second subset of the set of gears have a second predetermined gear ratio different from the first predetermined gear ratio; and
wherein the first scanner mirror is rotated responsive to actuation of the first subset and the second scanner mirror is rotated responsive to actuation of the second subset.

8. The beam scanning device of claim 1, wherein the second predetermined gear ratio is greater than the first predetermined gear ratio.

9. The beam scanning device of claim 1, wherein the first scanner mirror and the second scanner mirror rotate such that the beam of light completes the predetermined scanning pattern in at a rate of about 10 Hz.

10. The beam scanning device of claim 1, wherein the beam of light output is output from the beam scanning device and scans an external object in the predetermined scanning pattern.

11. The beam scanning device of claim 1, wherein the predetermined scanning pattern is a two-dimensional scanning pattern.

12. A time-of-flight (ToF) light detection and ranging (LIDAR) system, comprising:
a light source that emits a beam of light for a predetermined duration;
a beam scanner, comprising:
a first scanner mirror that reflects the beam of light generated by the light source, and steers the beam of light through a reflection mechanism;
a second scanner mirror that receives the beam of light from the reflection mechanism;
a set of gears coupled to the first scanner mirror and the second scanner mirror that when driven rotate the first scanner mirror and the second scanner mirror at predetermined speeds; and
an actuator that rotates the set of gears, the first scanner mirror, and the second scanner mirror at the predetermined speeds, causing the beam of light to reflect across the first and second scanner mirrors in a predetermined scanning pattern; and
a range detector that receives the beam of light responsive to the beam of light reflecting off an object in an external environment.

13. The ToF LIDAR system of claim 12, wherein the first and second scanner mirrors scan the beam of light in the same plane.

14. The ToF LIDAR system of claim 12, wherein the reflection mechanism comprises a mirror that rotates a scanned plane of the beam of light emitted from the first scanner mirror to be orthogonal to a scanning plane of the second scanner mirror.

15. The ToF LIDAR system of claim 12, wherein the actuator is one of a stepper motor, a servo motor, or an electric motor with a speed control device.

16. The ToF LIDAR system of claim 12, wherein the actuator further comprises an encoder or a position sensor that monitors and regulates a rotational speed of the actuator.

17. The ToF LIDAR system of claim 12, wherein a first subset of the set of gears have a first predetermined gear ratio, and a second subset of the set of gears have a second predetermined gear ratio different from the first gear ratio; and
wherein the first scanner mirror is rotated responsive to actuation of the first subset and the second scanner mirror is rotated responsive to actuation of the second subset.

18. A frequency-modulated continuous-wave (FMCW) light detection and ranging (LIDAR) system, comprising:
a light source that emits a beam of light continuously in a predetermined pattern of optical frequencies;
a beam scanner, comprising:
a first scanner mirror that reflects the beam of light generated by the light source, and steers the beam of light through a reflection mechanism, and a second scanner mirror that receives the beam of light from the reflection mechanism;
a set of gears coupled to the first scanner mirror and the second scanner mirror that when driven rotate the first scanner mirror and the second scanner mirror at predetermined speeds; and
an actuator that rotates the set of gears, the first scanner mirror, and the second scanner mirror at the predetermined speeds, causing the beam of light to reflect across the first and second scanner mirrors in a predetermined scanning pattern; and
a light receiver circuit that receives the beam of light responsive to the beam of light reflecting off an object in an external environment, and determines a distance to the object based on a frequency of the beam of light.

19. The FMCW LIDAR system of claim 18, wherein the first and second scanner mirrors scan the beam of light in the same plane.

20. The FMCW LIDAR system of claim 18, wherein the reflection mechanism comprises a mirror that rotates a scanned plane of the beam of light emitted from the first scanner mirror to be orthogonal to a scanning plane of the second scanner mirror.
